(19) United States
(12) Patent Application Publication
(10) Pub. No.: US 2026/0261065 A1
(43) Pub. Date: Sep. 3, 2026

(54) CONTACT PIN, SOCKET, AND PLUNGER

(71) Applicant: Enplas Corporation, Saitama (JP)

(72) Inventor: Yi Quan HONG, Saitama (JP)

(21) Appl. No.: 19/066,814

(22) Filed: Feb. 28, 2025

(51) Int. Cl. H01R 13/24; H01R 13/08

(52) U.S. Cl. CPC H01R 13/2421; H01R 13/08; H01R 13/2478

(57) ABSTRACT

A contact pin includes a pair of plungers capable of being pushed into a socket from respective directions in an upper-lower direction, in which the pair of plungers include plate surface parts, respectively, each plate surface part extending in the upper-lower direction and including an electrode part at one end side, the pair of plungers being disposed such that one electrode part faces upward, other electrode part faces downward, and the plate surface parts face each other, and one plate surface part includes a protrusion on both surfaces of a portion of the one plate surface part which comes to face other plate surface part when both of the pair of plungers are positioned at a push-in position, the protrusion being capable of making point contact or local contact with the other plate surface part.

### TECHNICAL FIELD

The present invention relates to a contact pin, a socket, and a plunger.

### BACKGROUND ART

An integrated circuit (IC) socket has been known as a socket for electrically connecting an electrical component such as an IC package packaging an IC to an external electrical component (e.g., wiring board), for example. The IC socket is used to inspect the electrical characteristics of the electronic component, for example, during inspection of the electronic component for shipping of the IC package.

The IC socket includes a plurality of contact pins at a base part in order to electrically connect the IC package and the wiring board, and each of the contact pins is installed so as to pass through a through-hole formed in the base part. The IC package is disposed on an upper surface side of the base part, the wiring board is disposed on a lower surface side of the base part, and upper ends of the contact pins are electrically connected to terminals of the IC package and lower ends of the contact pins are connected to terminals of the wiring board.

Each of the contact pins includes an upper plunger, a lower plunger, a spring, and the like. For example, a configuration of Patent Literature (hereinafter, referred to as “PTL”) 1 includes an upper plunger, a lower plunger, a spring, and the like, in which opposite end sides of the spring are locked to the upper plunger and the lower plunger, respectively. The upper plunger and the lower plunger include inclined surfaces in a sliding range where the upper and lower plungers slide with respect to each other, and in a state in which the spring is contracted in a through-hole, the inclined surfaces face each other and make contact with each other so as to be electrically connected to each other.

### CITATION LIST

### Patent Literature

PTL 1

WO2011/013731

### SUMMARY OF INVENTION

### Technical Problem

In the IC socket, maintenance of the IC socket and replacement of the contact pins may be performed from a cost perspective. When the IC socket is maintained, components constituting the IC socket including the contact pins need to be disassembled and then reassembled. The reassembly and replacement operations of the contact pins are not easy due to their fineness.

Since the inclined surfaces of the upper plunger and the lower plunger need to face each other in the case of the contact pins disclosed in PTL 1, assembly becomes more difficult. If the inclined surfaces do not face each other, the electrical connection may become unstable and the electrical characteristics may also become unstable. Therefore, a contact pin capable of improving assemblability and obtaining stable electrical characteristics is desired.

An object of the present invention is to provide a contact pin, a socket, and a plunger capable of improving assemblability and obtaining stable electrical characteristics.

### Solution to Problem

In order to achieve the above object, a contact pin according to the present invention includes:
a pair of plungers capable of being pushed into a socket from respective directions in an upper-lower direction, in which
the pair of plungers include plate surface parts, respectively, each of the plate surface parts extending in the upper-lower direction and including an electrode part at one of end sides, the pair of plungers being disposed such that one of the electrode parts faces upward, other one of the electrode parts faces downward, and the plate surface parts face each other, the pair of plungers being configured to be movable in the upper-lower direction between an initial position and a push-in position of each of the pair of plungers, and
one of the plate surface parts includes a protrusion on both surfaces of a portion of the one plate surface part which comes to face other one of the plate surface parts when both of the pair of plungers are positioned at the push-in position, the protrusion being capable of making point contact or local contact with the other plate surface part.

In order to achieve the above object, a socket according to the present invention includes:
a base part including a through-hole penetrating in an upper-lower direction; and
the above-described contact pin inserted into the through-hole, in which the electrode parts on upper and lower sides are electrically connectable to terminals of different electrical components, respectively.

In order to achieve the above object, a plunger according to the present invention is
a plunger forming a contact pin and capable of being pushed into a socket from one direction in an upper-lower direction, in which
the plunger includes a plate surface part extending in the upper-lower direction and including an electrode part at one of end sides, the plunger being configured to be movable in the upper-lower direction between an initial position and a push-in position, the plunger being disposed to be oriented opposite another plunger in the upper-lower direction in a state in which the plate surface part faces a plate surface part of the another plunger, the another plunger forming a pair with the plunger, and
the plate surface part includes a protrusion on both surfaces of a portion of the plate surface part which comes to face the plate surface part of the another plunger when both of the plunger and the another plunger are positioned at the push-in position, the protrusion being capable of making point contact or local contact with the plate surface part of the another plunger.

### Advantageous Effects of Invention

According to the present invention, assemblability can be improved, and stable electrical characteristics can be obtained.

### BRIEF DESCRIPTION OF DRAWINGS

FIG. 1 is a perspective view of a socket according to an embodiment of the present invention, and illustrates an upper surface side of the socket;

FIG. 2 is a sectional view of a part of a base part including a contact pin in socket shown in FIG. 1, showing a state prior to installation of a wiring board and an IC package;

FIG. 3A is a view showing an upper plunger that forms the contact pin, as seen in a plate-thickness direction of a plate surface part of the upper plunger;

FIG. 3B is a diagram showing the upper plunger forming the contact pin, as seen in a plate-width direction of the plate surface part of the upper plunger;

FIG. 3C is a perspective view showing a head portion and an electrode part o the upper plunger shown in FIGS. 3A and 3B;

FIG. 4 is a perspective view showing a variation of the electrode part shown in FIG. 3C;

FIG. 5A is a diagram for explaining a condition before the contact between protrusions of the upper plunger and the lower plunger and leg portions of the lower plunger and the upper plunger;

FIG. 5B is a view for explaining a condition when the protrusions of the upper plunger and the lower plunger are in contact with the leg portions of the lower plunger and the upper plunger;

FIG. 6 is a view for explaining a behavior when end portions of the upper plunger and the lower plunger constituting the contact pin come into contact with each other;

FIG. 7 illustrates a spring;

FIG. 8 is a sectional view showing through-holes in the base part through which the contact pin and the spring are inserted;

FIG. 9 is a sectional view of the base part and the spring in a portion of the base including the contact pins, and illustrates a state prior to installation of the wiring board and the IC package;

FIG. 10 is a sectional view of the base part and the spring in a portion of the base part including the contact pins, and illustrates a state of the IC package prior to installation after installation of the wiring board;

FIG. 11 is a sectional view of the base part and the spring in a portion of the base including the contact pins, and illustrates a state prior to installation of the wiring board and the IC package;

FIG. 12 is a view for explaining an arrangement pattern of the upper plunger and the lower plunger constituting the contact pin;

FIG. 13 is a perspective view illustrating a variation of the head portion and the electrode part of the upper plunger;

FIG. 14 is a perspective view showing another variation of the head portion an the electrode part of the upper plunger; and

FIG. 15 is a perspective view illustrating another variation of the head portion and the electrode part of the upper plunger.

### Description of Embodiments

Hereinafter, embodiments of the present invention will be described in detail with reference to the drawings.

In the present embodiment, an inspection socket for an inspection apparatus that inspects electric characteristics of an electrical component will be exemplified as a socket. This inspection apparatus performs various tests on the electrical component to be inspected. For example, the apparatus checks whether the electrical component appropriately operates in the same environment as an actual use environment of the electrical component or in an environment where a load greater than that in the actual environment is applied.

Further, the socket according to the present embodiment is an IC socket whose inspection target is an IC package, but an electrical component to be inspected by the socket may be an electrical component different from the IC package. The IC is an electronic circuit and includes transistors, resistances, capacitors, and inductors interconnected on a silicon substrate, for example.

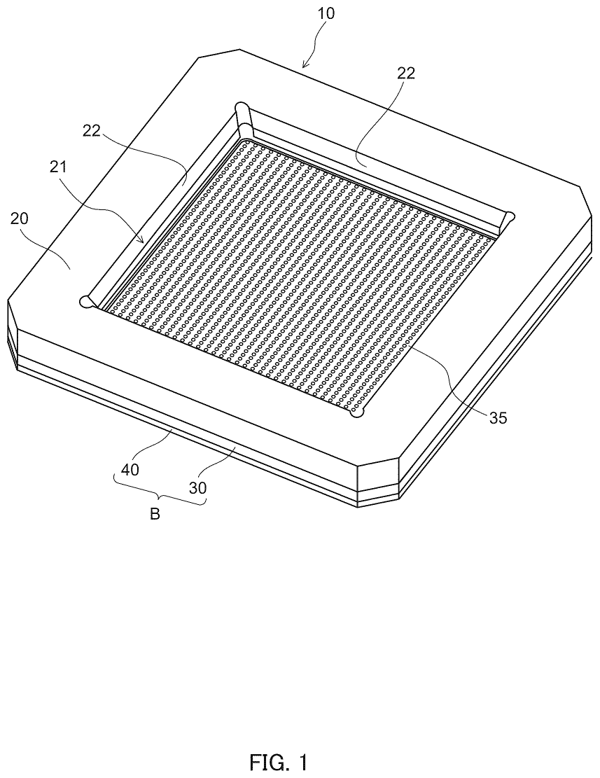

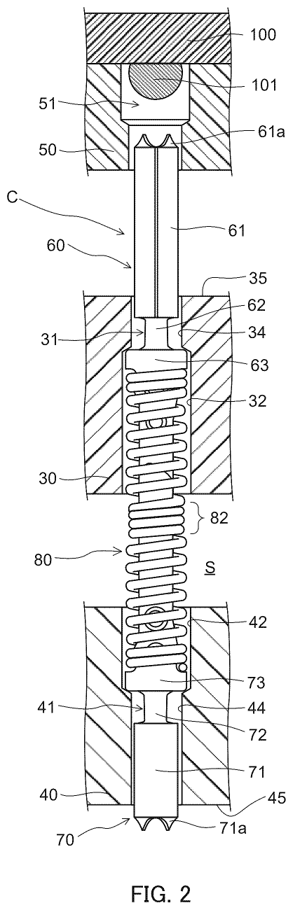

FIG. 1 is a perspective view of IC socket 10 according to an embodiment, and illustrates an upper surface side of IC socket 10. FIG. 2 is a sectional view of a part of base part B including contact pin C in IC socket 10 shown in FIG. 1, and is a view showing a condition prior to installation of wiring board 200 and IC package 100.

### IC Socket

IC socket 10 includes base part B on which IC package 100 (see FIG. 2) is placed via floating plate 50 (see FIG. 2), and frame part 20. Frame part 20 is disposed on the outer edge side of upper surface 35 of upper base part 30 forming base part B. The inner side of frame part 20 functions as accommodating portion 21 housing IC package 100. Note that, in the present invention, a thickness direction of base part B is referred to as an upper-lower direction, and in the following description, the terms “upper/up” and “lower/down” will indicate the up and down in this upper-lower direction.

IC package 100 is an exemplary electrical component according to the present invention (see FIG. 2). In the present embodiment, an IC package such as a Ball Grid Array (BGA) type and a Land Grid Array (LGA) type can be applied as IC package 100. Here, as shown in FIG. 2, IC package 100 of the BGA type is illustrated.

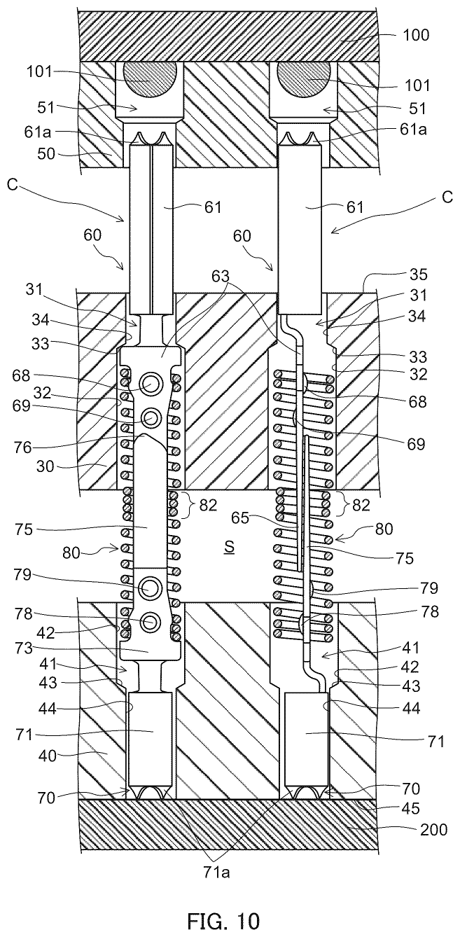

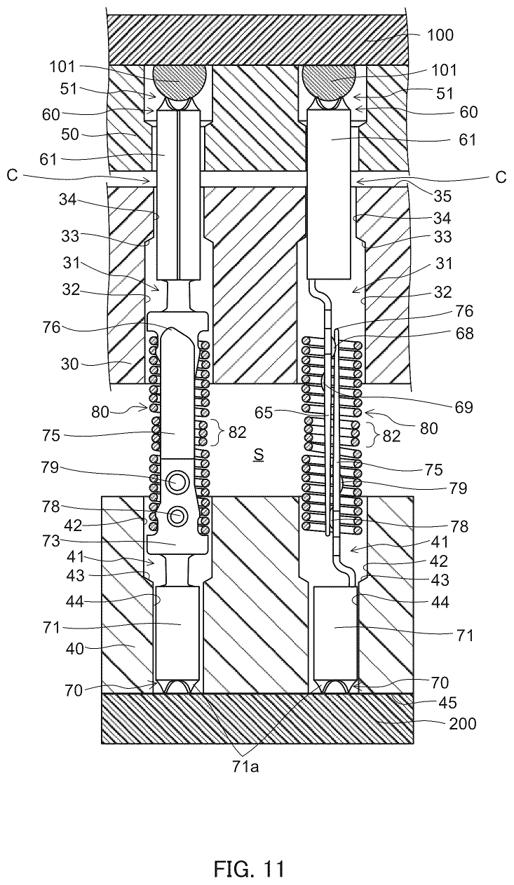

As shown in FIGS. 10 and 11, which will be described later, wiring board 200 is attached to lower surface 45 (see FIG. 2) of lower base part 40 constituting base part B. Wiring board 200 is an example of an electrical component in the present invention. In the present embodiment, wiring board 200 is a wiring board of an inspection apparatus for performing the above-described various tests.

### Frame Part

As shown in FIG. 1, frame part 20 is a frame body in which a central portion is opened in the upper-lower direction and an opening portion thereof is surrounded, and forms an outer peripheral portion of accommodating portion 21. In the present embodiment, the shape of the opening portion is a rectangular shape, but can be appropriately changed depending on the shape of IC package 100 to be housed.

Floating plate 50 is disposed on upper surface 35 of upper base part 30 inside frame part 20 vertically movable via a plurality of springs (not shown). Floating plate 50 is a planar member having a predetermined thickness. Floating plate 50 includes a plurality of through-holes 51 that receive terminals 101 of IC package 100 therein and penetrate therethrough in the upper-lower direction. The plurality of through-holes 51 are provided in floating plate 50 in accordance with the numbers and arrangements of the plurality of terminals 101 of IC package 100.

Guide portion 22 for guiding IC package 100 to a correct position on floating plate 50 in accommodating portion 21 is provided on the inner peripheral side of frame part 20, that is, on the inner wall of accommodating portion 21. Since a known technique can be applied to guide portion 22 for guiding IC package 100 to the correct position, detailed explanation thereof will be omitted here.

IC package 100 is guided by guide portion 22 to the correct position on floating plate 50 in accommodating portion 21. IC package 100 accommodated in accommodating portion 21, together with the floating plate 50, is pressed downward by a pressing member (not shown). A plurality of contact pins C, which will be described later, are disposed in base part B. By pressing IC package 100 by the pressing member, solder ball-shaped terminal 101 of IC package 100 is brought into contact with electrode part 61a of upper plunger 60 of contact pin C disposed in base part B.

Further, wiring board 200 is attached to lower surface 45 of lower base part 40 so that a terminal (not shown) of wiring board 200 abuts on electrode part 71a of lower plunger 70 of contact pin C disposed in base part B.

In use, IC socket 10 accommodates IC package 100 in accommodating portion 21 and presses IC package 100 downward by the pressing member. As a result, contact pins C electrically connect terminals 101 of IC package 100 accommodated in accommodating portion 21 to the terminals of wiring board 200 attached to lower surface 45 of lower base part 40.

### Base Part

Base part B includes upper base part 30 and lower base part 40. In the upper-lower direction, upper base part 30 is disposed on the side of IC package 100, and lower base part 40 is disposed on the side of wiring board 200.

### Upper Base Part

Upper base part 30 disposed on the IC package 100 side (upper side) forms a bottom portion of accommodating portion 21, and upper surface 35 of upper base part 30 serves as the bottom surface of accommodating portion 21.

Upper base part 30 is a planar member having a predetermined thickness, and is formed of, for example, an insulating material such as synthetic resin.

Upper base part 30 includes a plurality of through-holes 31 for contact pins C that penetrate in the upper-lower direction. In FIG. 2, only one contact pin C and its through-hole 31 are shown.

In upper base part 30, through-holes 31 are disposed to correspond to the number, arrangement, and the like of through-holes 51 in floating plate 50. That is, in upper base part 30, through-holes 31 are disposed to correspond to the numbers, arrangements, and the like of terminals of IC package 100.

Contact pin C and an upper side of spring 80 to be described later are inserted through through-hole 31, and a part of head portion 61 of upper plunger 60 is exposed above upper surface 35. Through-hole 31 will be described later with reference to FIG. 8.

### Lower Base Part

Lower base part 40 disposed on the wiring board 200 side (lower side) includes a hollow recessed portion (not shown) on the upper base part 30 side (upper side), and the hollow recessed portion is configured to form hollow portion S between upper base part 30 and the lower base part.

Lower base part 40 is configured as a planar member having a predetermined thickness, in which the hollow recessed portion is formed in a region where a plurality of contact pins C are arranged, and is formed of an insulating material such as synthetic resin.

Hollow portion S is filled with air, and the relative dielectric constant of hollow portion S is smaller than the relative dielectric constant of upper base part 30 or lower base part 40. As a result, the dielectric loss occurring around contact pin C is reduced, and deterioration of high-frequency characteristics of a signal can be suppressed at the time of inspection.

Here, as an example, the hollow recessed portion is formed in lower base part 40, so as to form hollow portion S between upper base part 30 and the lower base part, the hollow recessed portion may be formed in the upper base part 30, so as to form hollow portion S between lower base part 40 and the upper base part. In addition, the hollow recessed portion may be formed in both upper base part 30 and lower base part 40 to form hollow portion S between upper base part 30 and lower base part 40. In addition, hollow portion S may not be present, and upper base part 30 may overlap on lower base part 40.

Lower base part 40 includes a plurality of through-holes 41 for contact pins C that penetrate the lower base part in the upper-lower direction. In lower base part 40, through-holes 41 are disposed to correspond to the number, arrangement, and the like of the through-holes 51 in floating plate 50 and through-holes 31 in upper base part 30. That is, in lower base part 40, through-holes 41 are disposed to correspond to the numbers, arrangements, and the like of the terminals of IC package 100.

Lower sides of contact pin C and spring 80 are inserted through through-holes 41, and a part of head portion 71 of lower plunger 70 is disposed to be exposed below lower surface 45. Through-holes 41 will also be described later with reference to FIG. 8.

### Contact Pin

A plurality of contact pins C are disposed in base part B, and electrically connect terminals 101 of IC package 100 to the terminals of wiring board 200. As shown in FIG. 2, contact pin C includes upper plunger 60, lower plunger 70, and spring 80.

As will be described later, the pair of upper plunger 60 and lower plunger 70 can be pushed into IC socket 10 from the respective directions in the upper-lower direction, and are supported by spring 80 so as to be movable in the upper-lower direction between an initial position and a push-in position. Further, when IC package 100 and wiring board 200 are installed in base part B, an external force that pushes down IC package 100 or pushes up wiring board 200 also acts on upper plunger 60 and lower plunger 70. Therefore, prior to installation of IC package 100 and wiring board 200, spring 80 positions upper plunger 60 and lower plunger 70 in their respective initial positions. On the other hand, when IC package 100 and wiring board 200 are installed, upper plunger 60 and lower plunger 70 are pushed into IC socket 10 from the respective directions in the upper-lower direction against spring 80 by the external force, and are positioned at the respective push-in positions.

### Plunger

Upper plunger 60 and lower plunger 70 have essentially the same configuration. Here, upper plunger 60 and lower plunger 70 are exemplified to have different lengths of head portion 61 and head portion 71, but the configurations of upper plunger 60 and lower plunger 70 are the same except for this point.

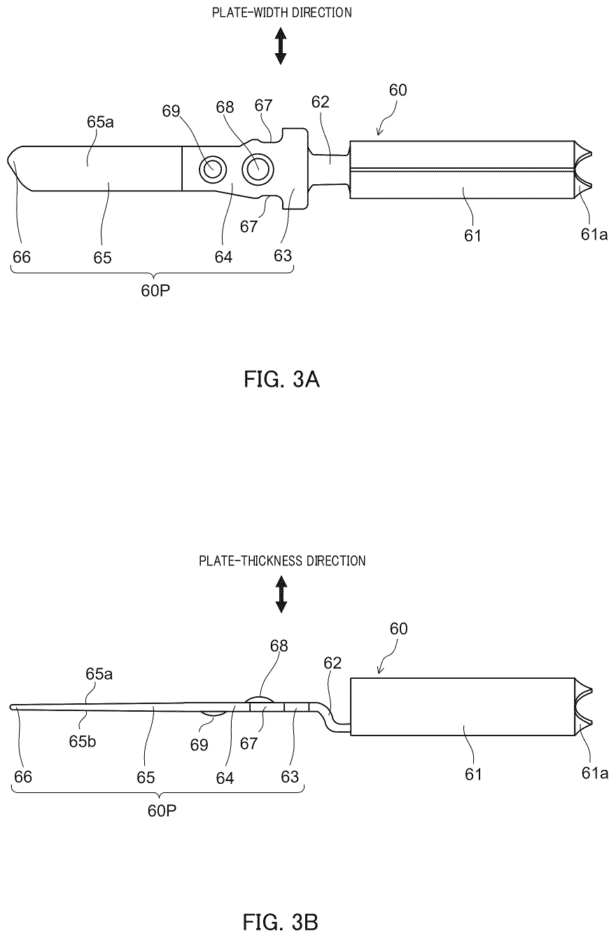

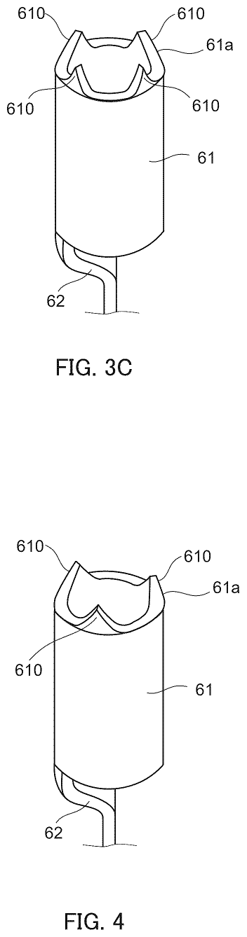

FIG. 3A is a diagram showing upper plunger 60 forming contact pin C, as viewed from a plate-thickness direction of plate surface part 60P of upper plunger 60. FIG. 3B is a diagram showing upper plunger 60 forming contact pin C, as viewed from a plate-width direction of plate surface part 60P of upper plunger 60. FIG. 3C is a perspective view showing head portion 61 and electrode part 61a of upper plunger 60 shown in FIG. 3A and FIG. 3B. FIG. 4 is a perspective view illustrating a variation of electrode part 61a illustrated in FIG. 3C.

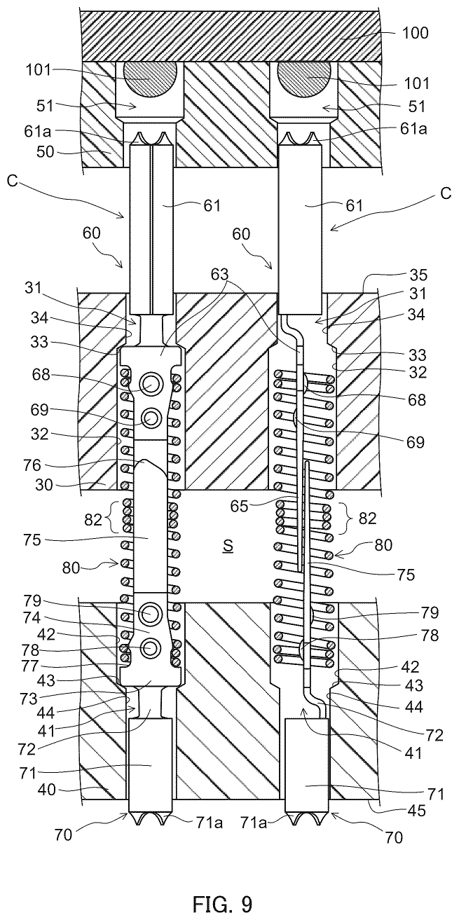

Here, only upper plunger 60 is illustrated in FIGS. 3A to 3C and FIG. 4, and lower plunger 70 will be referred to FIG. 9 and the like which will be described later. Further, the plate-thickness direction is the direction of the thick-line arrow shown in FIG. 3B, the plate-width direction is the direction of the thick-line arrow shown in FIG. 3A, these are the directions orthogonal to each other, and the directions orthogonal to the upper-lower direction. The plate-thickness direction and the plate-width direction similarly apply for lower plunger 70.

Upper plunger 60 is inserted into spring 80 from above, and is disposed in through-hole 31 in upper base part 30 with head portion 61 exposed from upper surface 35 of upper base part 30. Upper plunger 60 is a member extending in a longitudinal direction that is the upper-lower direction when installed, and is formed of a conductive material such as metal. Upper plunger 60 includes head portion 61, neck portion 62, shoulder portion 63, trunk portion 64, leg portion 65, and end portion 66 from one longitudinal end side (the right side in FIGS. 3A and 3B) toward the other end side (the left side in FIGS. 3A and 3B).

Lower plunger 70 is inserted into spring 80 from below, and is disposed in through-hole 41 in lower base part 40 with head portion 71 exposed from lower surface 45 of lower base part 40. Lower plunger 70 has a configuration similar to that of upper plunger 60, and includes head portion 71, neck portion 72, shoulder portion 73, trunk portion 74, leg portion 75, and end portion 76 from one longitudinal end side (lower side in FIG. 9) toward the other end side (upper side in FIG. 9).

Head portion 61 includes electrode part 61a at one end. When IC package 100 is installed (see FIG. 11 described later), electrode part 61a is installed to face upward, abuts on terminal 101 of IC package 100, and is electrically connected to terminal 101. Head portion 71 has a configuration similar to that of head portion 61, and has electrode part 71a at one end. When wiring board 200 is installed (see FIG. 10 to be described later), electrode part 71a is installed to face downward, comes into contact with the terminal of wiring board 200, and is electrically connected to the terminal. That is, upper plunger 60 and lower plunger 70 are arranged to face in the opposite directions in the upper-lower direction.

As an example, head portions 61 and 71 are formed by rounding a flat plate material into a cylindrical shape. Electrode part 61a is, for example, crown-shaped, and includes, for example, four protruding electrodes 610 along a circle which is a shape of one end side of head portion 61 as shown in 3C. The number of protruding electrodes 610 in electrode part 61a is not particularly limited. For example, in the case of IC packages of the BGA type as in the present embodiment, it is preferable that a plurality of protruding electrodes 610 are provided, and for example, as shown in FIG. 4, three protruding electrodes 610 may be provided. In IC packages (e.g., LGA type) other than those of the BGA type, it is preferable that one or more protruding electrodes be provided. Electrode part 71a has a configuration similar to that of electrode part 61a, and is, for example, crown-shaped, and includes a plurality of protruding electrodes (not shown).

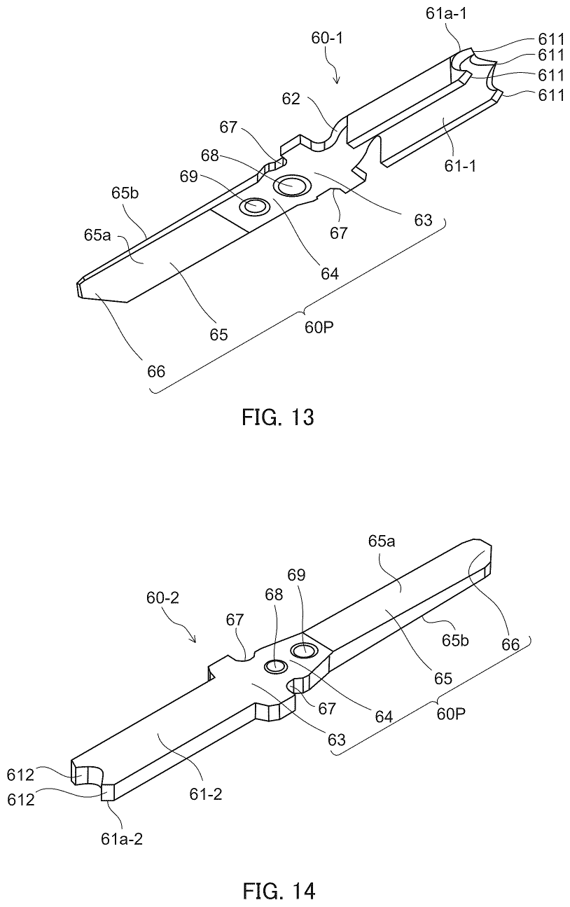

Note that head portions 61 and 71 are not limited to the above-described shapes, and may be, for example, a shape obtained by bending a plate member having a flat plate shape such that the plate member has a U-shaped cross section or a cross section in a U shape turned sideways, or the shape of a plate member having a flat plate shape, as shown in FIGS. 13 to 15 described later. Further, the shapes of electrode parts 61a, 71a may be appropriately changed in accordance with the shape of terminal 101 or the like and the shapes of head portions 61 and 71.

Neck portion 62 is a portion between head portion 61 and shoulder portion 63, and is narrower than head portion 61 and shoulder portion 63 when viewed in the plate-thickness direction as shown in FIG. 3A, and is formed in a crank-shape or an S-shape when viewed in the plate-width direction as shown in FIG. 3B. Neck portion 62 is elastically deformable, and supports the side including shoulder portion 63, trunk portion 64, leg portion 65, and end portion 66 so as to be displaceable with respect to head portion 61. Neck portion 72 has a configuration similar to that of neck portion 62, is elastically deformable, and supports the side including shoulder portion 73, trunk portion 74, leg portion 75, and end portion 76 so as to be displaceable with respect to the head portion 71.

Shoulder portion 63, trunk portion 64, leg portion 65, and end portion 66 are flat plate-shaped portions extending in the longitudinal direction that is the upper-lower direction at the time of installation. Shoulder portion 73, trunk portion 74, leg portion 75, and end portion 76 are also flat plate-shaped portions extending in the longitudinal direction that is the upper-lower direction when installed.

As shown in FIG. 3A, shoulder portion 63 is wider than head portion 61 and neck portion 62 when viewed from the plate-thickness direction, and the opposite ends of the shoulder portion in the width direction (direction perpendicular to the longitudinal direction) located on the head portion 61 side are formed so as to be locked to upper locking portion 33 of through-hole 31 described later. Shoulder portion 73 has the same configuration as shoulder portion 63, and the opposite ends of the shoulder portion in the width direction on the head portion 71 side are formed so as to be locked to lower locking portion 43 of through-hole 41 described later.

Recessed portions 67 making the width narrower when viewed in the plate-thickness direction are formed in upper plunger 60 at the opposite ends in the width direction between shoulder portion 63 and trunk portion 64, as shown in FIG. 3A. Similarly, recessed portions 77 making the width narrower when viewed from the plate-thickness direction of the plate surface part of lower plunger 70 is formed in lower plunger 70 at the opposite ends in the width direction between shoulder portion 73 and trunk portion 74. Windings of the opposite end portions of spring 80 is fitted in recessed portions 67 and 77, and spring 80 supports upper plunger 60 and lower plunger 70 movably in the expansion and contraction direction of the spring.

Shoulder portion 63, trunk portion 64, leg portion 65, and end portion 66 correspond to the plate surface part (plate surface part 60P) in the present invention, and shoulder portion 73, trunk portion 74, leg portion 75, and end portion 76 also correspond to the plate surface part in the present invention. Trunk portion 64, leg portion 65, and end portion 66, and trunk portion 74, leg portion 75, and end portion 76 are disposed facing each other when upper plunger 60 and lower plunger 70 are installed.

Trunk portion 64 is a portion between shoulder portion 63 and leg portion 65. When the upper side of trunk portion 64 is a front surface and the lower side of trunk portion 64 is a back surface in the figure viewed from the plate-width direction shown in FIG. 3B, trunk portion 64 includes protrusions 68 and 69 locally protruding from the front surface and the back surface, respectively. Protrusions 68 and 69 are disposed on the front and back surfaces of a portion of trunk portion 64 that comes to face leg portion 75 when upper plunger 60 and lower plunger 70 are positioned in the push-in position.

Trunk portion 74 has a configuration similar to that of trunk portion 64, and includes protrusions 78 and 79 that locally protrude from the front surface and the back surface, respectively. Protrusions 78 and 79 are disposed on the front and back surfaces of a portion of trunk portion 74 that comes to face leg portion 65 when upper plunger 60 and lower plunger 70 are positioned in the push-in position.

Here, protrusions 68 and 69 and protrusions 78 and 79 locally protrude from trunk portion 64 and trunk portion 74 in a hemispherical shape or a spherical segment shape, respectively, so as to make point contact or local contact with leg portions 65 and 75 being a contact target. The contact between protrusions 68 and 69 and leg portion 75 and the contact between protrusions 78 and 79 and leg portion 65 change from a point contact state to a local contact state in which they come into contact in a small area in accordance with a force exerted between them when they come into contact. Note that protrusions 68 and 69 and protrusions 78 and 79 are not limited to a hemispherical shape or a spherical segment shape as long as they locally protrude. For example, the shapes of trunk portion 64 and trunk portion 74 curved on the front and back sides in an S shape as seen in a section may be the protrusions on the front and back sides.

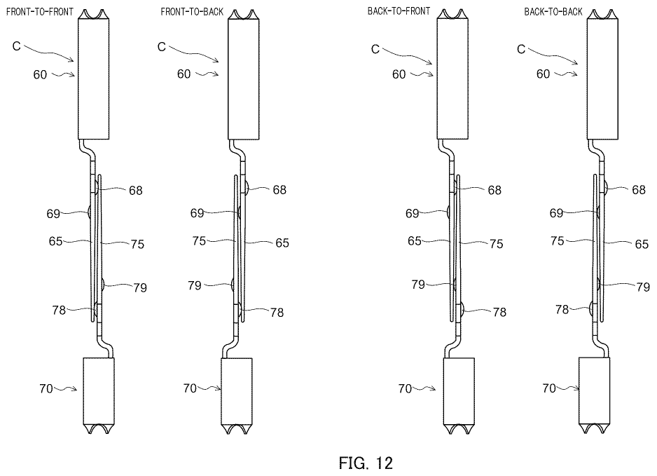

In addition, depending on an arrangement pattern of upper plunger 60 and lower plunger 70, protrusion 68 or protrusion 69 comes into point contact or local contact with leg portion 75 of lower plunger 70, and protrusion 78 or protrusion 79 comes into point contact or local contact with leg portion 65 of upper plunger 60. These details will be described later with reference to FIG. 12. Such point contact or local contact electrically connects upper plunger 60 to lower plunger 70 regardless of the arrangement pattern of upper plunger 60 and lower plunger 70.

Leg portion 65 as seen from the plate-thickness direction has the same width as trunk portion 64 as shown in FIG. 3A, but is formed to have a thickness decreasing from the end portion on the side of trunk portion 64 towards end portion 66 on the other end side on the tip end side as seen from the plate-width direction as shown in FIG. 3B. That is, front surface 65a of leg portion 65 is formed as an inclined surface so as to be inclined with respect to the upper-lower direction such that spaced-apart protrusion 78 or protrusion 79 comes into close contact with front surface 65a as the position of protrusion 78 or protrusion 79 of lower plunger 70 approaches trunk portion 64. Further, back surface 65b of leg portion 65 is also formed as an inclined surface so as to be inclined with respect to the upper-lower direction such that spaced-apart protrusion 78 or protrusion 79 comes close to and comes into contact with back surface 65b as the position of protrusion 78 or protrusion 79 approaches trunk portion 64. Note that one of front surface 65a and back surface 65b may be formed to be the inclined surface.

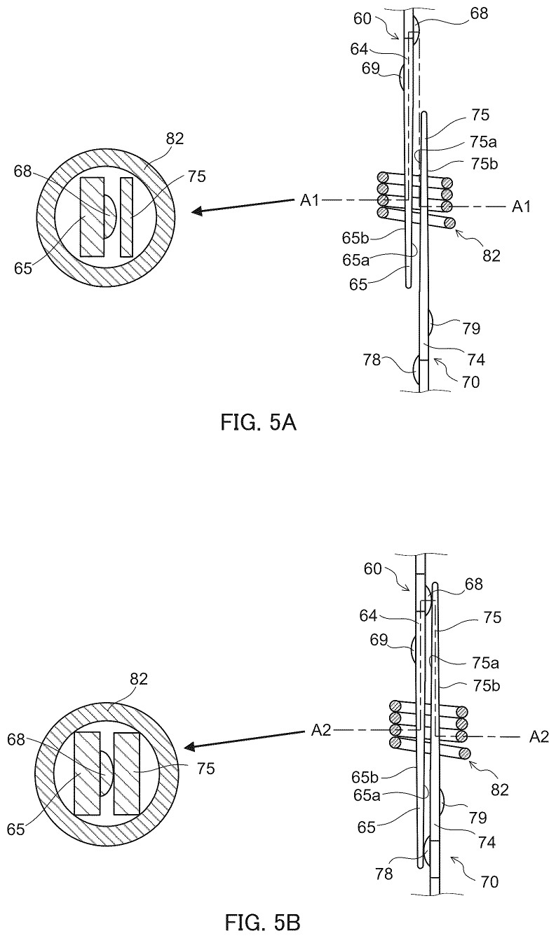

Leg portion 75 has a configuration similar to that of leg portion 65. Front surface 75a and back surface 75b of leg portion 75 (see FIGS. 5A and 5B) are formed as inclined surfaces so as to be inclined such that spaced-apart trunk portion 68 or protrusion 69 comes into close contact with front and back surfaces 75a and 75b as the position of protrusion 68 or protrusion 69 of upper plunger 60 approaches trunk portion 74. Note that one of front surface 75a and back surface 75b may be formed to be the inclined surface.

Here, FIG. 5A is a view for explaining a condition prior to contact between protrusion 68 of upper plunger 60 and leg portion 75 of lower plunger 70, and contact between protrusion 78 of lower plunger 70 and leg portion 65 of upper plunger 60. Further, FIG. 5B is a view for explaining a condition when protrusion 68 of upper plunger 60 makes contact with leg portion 75 of lower plunger 70, and protrusion 78 of lower plunger 70 makes contact with leg portion 65 of upper plunger 60. Here, as an example, a case where protrusion 68 and leg portion 75 are in contact with each other and a case where protrusion 78 and leg portion 65 are in contact with each other will be described, but the same applies to a case where protrusion 69 and leg portion 75 are in contact with each other and a case where protrusion 79 and leg portion 65 are in contact with each other.

In a state prior to installation of wiring board 200 and IC package 100, upper plunger 60 and lower plunger 70 connected to the end portions of spring 80 are biased upward and downward by the biasing force of spring 80, respectively. As described above, upper plunger 60 and lower plunger 70, which are biased upward and downward, have shoulder portion 63 locked to upper locking portion 33 and shoulder portion 73 locked to lower locking portion 43, respectively, and are thus arranged at the upper limit position and the lower limit position. The lower limit position is the initial position of upper plunger 60 and lower plunger 70. At this time, in upper plunger 60 and lower plunger 70, leg portion 65 and leg portion 75 face each other as shown in FIG. 9 described later.

When wiring board 200 is installed, as shown in FIG. 10, which will be described later, lower plunger 70 is pushed up by wiring board 200, and the position of lower plunger 70 is determined. This position is the push-in position of lower plunger 70. Then, when IC package 100 disposed on floating plate 50 is pushed downward, upper plunger 60 is pushed downward by IC package 100 (terminal 101) and the position of upper plunger 60 is determined, as shown in FIG. 11, which will be described later. This position is the push-in position of upper plunger 60.

The above-described inclined surface (front surface 75a) is formed on leg portion 75 of lower plunger 70. Therefore, protrusion 68 is separated from front surface 75a before upper plunger 60 is pushed downward. When the position of at least one of upper plunger 60 and lower plunger 70 is the initial position, protrusion 68 is separated from front surface 75a. Then, when upper plunger 60 is pushed downward and upper plunger 60 moves downward, protrusion 68 is brought, from a state of being away from front surface 75a that the protrusion faces, to a state of being close to front surface 75a, and finally, protrusion 68 comes into contact with front surface 75a.

Similarly, the above-described inclined surface (front surface 65a) is also formed on leg portion 65 of upper plunger 60. Therefore, protrusion 78 is separated from the front 65a before upper plunger 60 is pushed downward. When the position of at least one of upper plunger 60 and lower plunger 70 is the initial position, protrusion 78 is separated from front surface 65a. Then, when upper plunger 60 is pushed downward and upper plunger 60 moves downward, protrusion 78 is brought, from a state of being away from front surface 65a that the protrusion faces, to a state of being close to front surface 65a, and finally, protrusion 78 comes into contact with front surface 65a.

In this manner, protrusion 68 is brought into contact with leg portion 75, and protrusion 78 is brought into contact with leg portion 65 at some point while upper plunger 60 is pushed downward, and protrusion 68 and leg portion 75 are not always in contact with each other and protrusion 78 and leg portion 65 are not always in contact with each other. Therefore, when upper plunger 60 is pushed downward, protrusion 68 and leg portion 75 do not always slide on each other (rub against each other), and protrusion 78 and leg portion 65 do not always slide on each other (rub against each other). As described above, since protrusion 68 and leg portion 75 do not always slide on each other, and protrusion 78 and leg portion 65 do not always slide on each other, the life of the plating on the surface of protrusion 68 and the surface of protrusion 78 can be extended, and the durability of contact pin C can be improved.

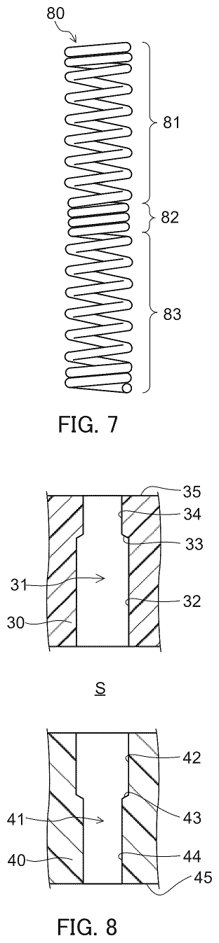

Further, spring 80 has reduced-diameter portion 82 (restricting portion in the present invention) as described later with reference to FIG. 7. Reduced-diameter portion 82 allows movement of leg portion 65 and leg portion 75 in a state where protrusion 68 is not in contact with leg portion 75 and a state where protrusion 78 is not in contact with leg portion 65 as shown in the left diagram in FIG. 5A. In addition, reduced-diameter portion 82 restricts the movement of leg portion 65 and leg portion 75 in a state where protrusion 68 is in contact with leg portion 75 and a state where protrusion 78 is in contact with leg portion 65 as shown in the left diagram in FIG. 5B. Reduced-diameter portion 82 has an inner diameter satisfying these two conditions. Therefore, in a state in which protrusion 68 is in contact with leg portion 75 and a state in which protrusion 78 is in contact with leg portion 65, reduced-diameter portion 82 further restricts the movement of leg portion 65 and leg portion 75 (radially outward movement), so that protrusion 68, leg portion 75, protrusion 78, and leg portion 65 can be reliably in contact with each other.

Note that the left diagram in FIG. 5A is a cross-sectional view taken along line A1-A1 in a state in which protrusion 68 is not in contact with leg portion 75 as shown in the right diagram of FIG. 5A, and the left diagram in FIG. 5B is a cross-sectional view taken along line A2-A2 in a state in which protrusion 68 is in contact with leg portion 75 as shown in the right diagram of FIG. 5B.

End portion 66 is a portion on the other end side of upper plunger 60 (the left side in FIGS. 3A and 3B), that is, a portion on the tip end side of leg portion 65, and is formed in a scalene triangle shape that narrows toward the tip end on the other end side when viewed in the plate-thickness direction as shown in FIG. 3A. End portion 76 has a configuration similar to that of end portion 66, and is formed in a scalene triangle shape which is a portion on the other end side of lower plunger 70, that is, a portion on the tip end side of leg portion 75, and which narrows toward the tip end on the other end side when viewed in the plate-thickness direction of the plate surface part of lower plunger 70.

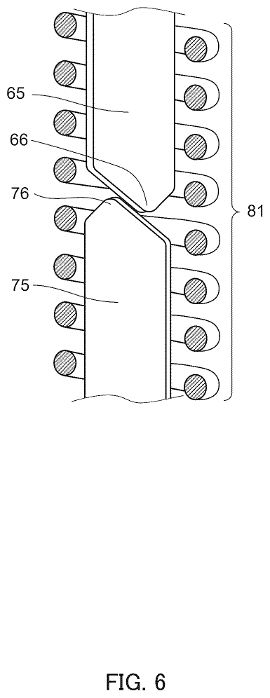

FIG. 6 is a view for explaining a behavior when end portions 66 and 76 of upper plunger 60 and lower plunger 70 constituting contact pin C come into contact with each other.

When upper plunger 60 and lower plunger 70 are assembled, lower plunger 70 is inserted into spring 80 from below, and then upper plunger 60 is inserted from above.

At this time, if end portions 66 and 76 are rectangular in shape, end portions 66 and 76 may be caught by each other and become immovable. Therefore, it is necessary to insert upper plunger 60 in consideration of the direction of leg portion 65 with respect to leg portion 75 (so that leg portion 75 and leg portion 65 are substantially parallel to each other) to prevent end portions 66 and 76 from being caught by each other and from being caused to be unmovable. Thus, the assemblability is not good. Further, even if end portions 66 and 76 have an isosceles triangular shape, there is a possibility that the apexes thereof are caught by each other and become unmovable.

Therefore, in the present embodiment, end portions 66 and 76 are formed in a scalene triangle shape. By forming end portions 66 and 76 in a scalene triangle shape, the possibility that the apexes thereof are caught by each other becomes small, and in most cases, the apex on the end portion 66 side comes into contact with the side on the end portion 76 side.

In this case, since the apex on the end portion 66 side comes into contact with the inclined side on the end portion 76 side, end portion 66 is rotated while sliding along the inclined side on the end portion 76 side by a force such as the self-weight of the upper plunger 60 itself or a force caused by swinging base part B, and moves to a predetermined position. As described above, since end portions 66 and 76 have a scalene triangle shape, it is not necessary to insert upper plunger 60 in consideration of the direction of leg portion 65 with respect to leg portion 75, and the assemblability is improved. Note that the shapes of end portions 66 and 76 are not particularly limited as long as the same functions and effects as described above can be obtained, and shapes other than the scalene triangle shape may be used.

In addition, upper plunger 60 and lower plunger 70 described above can be formed by press working, and only head portions 61 and 71 need to be curled into a cylindrical shape after the press working, so that the manufacturing cost can be reduced.

### Spring

FIG. 7 is a diagram illustrating spring 80. Spring 80 preferably includes upper enlarged-diameter portion 81, reduced-diameter portion 82, and lower enlarged-diameter portion 83.

Upper enlarged-diameter portion 81 has a diameter larger than that of reduced-diameter portion 82, causing a winding on the end portion side to be caught by recessed portion 67 of upper plunger 60. Upper enlarged-diameter portion 81 is longitudinally expandable and contractible.

Reduced-diameter portion 82 is disposed in an intermediate portion of spring 80, and has a diameter smaller than those of upper enlarged-diameter portion 81 and lower enlarged-diameter portion 83 at opposite ends. Reduced-diameter portion 82 has an inner diameter that restricts movement of leg portion 65 and leg portion 75 caused due to a reaction force caused by the contact of protrusion 68 or protrusion 69 making contact with leg portion 75 and of protrusion 78 or protrusion 79 making contact with leg portion 65.

Reduced-diameter portion 82 is formed in a state of being tightly wound at a predetermined position in the longitudinal direction in order to restrict the movement of leg portion 65 and leg portion 75 at predetermined positions. By changing the inner diameter and the number of turns (length) of reduced-diameter portion 82, the force for restricting the movement of leg portion 65 and leg portion 75 can be adjusted. As a result, it is possible to adjust the force that protrusion 68 or protrusion 69 and leg portion 75 come into contact with each other or the force that protrusion 78 or protrusion 79 and leg portion 65 come into contact with each other.

Lower enlarged-diameter portion 83 has a diameter larger than that of reduced-diameter portion 82, causing a winding on the end portion side to be caught by recessed portion 77 of lower plunger 70. Lower enlarged-diameter portion 83 is longitudinally expandable and contractible.

Upper plunger 60 is inserted into spring 80 from above, and a winding of the upper end portion of spring 80 is fitted into recessed portion 67. Further, lower plunger 70 is inserted into spring 80 from below, and a winding of the lower end portion of spring 80 is fitted into recessed portion 77. Accordingly, spring 80 supports upper plunger 60 and lower plunger 70 so as to be movable in the expansion and contraction direction.

Spring 80 is disposed so as to be contracted in through-hole 31 and through-hole 41. Therefore, upper plunger 60 is biased upward by the biasing force of spring 80, and shoulder portion 63 is brought into contact with and locked by upper locking portion 33 of through-hole 31. Similarly, lower plunger 70 is biased downward so that shoulder portion 73 is brought into contact with and locked by lower locking portion 43 of through-hole 41.

### Through-hole

FIG. 8 is a sectional view showing through-holes 31 and 41 in base part B through which contact pin C and spring 80 are inserted.

One through-hole 31 in upper base part 30 and one through-hole 41 of lower base part 40 opposed to one through-hole 31 via hollow portion S form one through-hole in which one contact pin C is disposed.

Contact pin C is disposed in through-holes 31 and 41 together with spring 80 such that head portion 61 of upper plunger 60 is exposed above upper surface 35 and head portion 71 of lower plunger 70 is exposed below lower surface 45.

As illustrated in FIG. 8, through-hole 31 includes upper main portion 32, upper locking portion 33, and upper reduced-diameter portion 34.

Upper main portion 32 is a portion having an inner diameter larger than that of upper reduced-diameter portion 34, and upper enlarged-diameter portion 81 of spring 80 and upper plunger 60 are disposed in the upper main portion.

Upper locking portion 33 is a portion whose inner diameter decreases from upper main portion 32 toward upper reduced-diameter portion 34, and is disposed on the upper end side of upper main portion 32. As described above, shoulder portion 63 is locked by upper locking portion 33. Accordingly, upper plunger 60 is prevented from coming out upward from through-hole 31. Here, upper locking portion 33 has a tapered shape that decreases in diameter upward, but may have a stepped shape.

Upper reduced-diameter portion 34 is a portion having an inner diameter smaller than that of upper main portion 32 and larger than the outer diameter of head portion 61 of upper plunger 60, is disposed on the upper end side of upper locking portion 33, and opens in upper surface 35.

Similarly, as illustrated in FIG. 8, through-hole 41 includes lower main portion 42, lower locking portion 43, and lower reduced-diameter portion 44.

Lower main portion 42 is a portion having an inner diameter larger than that of lower reduced-diameter portion 44, and lower enlarged-diameter portion 83 and lower plunger 70 of spring 80 are disposed in the lower main portion.

Lower locking portion 43 is a portion whose inner diameter decreases from lower main portion 42 toward lower reduced-diameter portion 44, and is disposed on the lower end side of lower main portion 42. As described above, shoulder portion 73 is locked by lower locking portion 43. As a result, lower plunger 70 is prevented from coming out downward from through-hole 41. Here, lower locking portion 43 has a tapered shape decreasing in diameter downward, but may have a stepped shape.

Upper reduced-diameter portion 34 is a portion having an inner diameter smaller than that of lower main portion 42 and larger than the outer diameter of head portion 71 of lower plunger 70, is disposed on the upper end side of lower locking portion 43, and opens in lower surface 45.

### Contact State of Upper Plunger and Lower Plunger

The contact state of upper plunger 60 and lower plunger 70 in contact pin C will be described with reference to FIGS. 9 to 11.

FIGS. 9 to 11 are cross-sectional views showing base part B and spring 80 in a cross section in a portion of base part B including contact pin C. FIG. 9 is a diagram showing a state before wiring board 200 and IC package 100 are installed, FIG. 10 is a diagram showing a state before IC package 100 is installed after the wiring board 200 is installed, and FIG. 11 is a diagram showing a state after wiring board 200 and IC package 100 are installed. In FIGS. 9 to 11, spring 80 is shown in cross section so that the state of upper plunger 60 and the state of lower plunger 70 can be seen, and upper plunger 60 and lower plunger 70 as seen in the plate-thickness direction and the plate-width direction are respectively shown in the diagrams.

Next, referring to FIG. 9, the contact state of upper plunger 60 and lower plunger 70 before wiring board 200 and IC package 100 are installed will be described.

Prior to installation of wiring board 200 and IC package 100, upper plunger 60 and lower plunger 70 are biased upward and downward by the biasing force of spring 80. Upper plunger 60 and lower plunger 70 biased upward and downward are disposed at the upper limit position and the lower limit position (initial positions), respectively, since shoulder portion 63 is locked to upper locking portion 33 and shoulder portion 73 is locked to lower locking portion 43.

In the state illustrated in FIG. 9, upper plunger 60 and lower plunger 70 are in a state in which leg portion 65 and leg portion 75 face each other, and leg portion 65 and leg portion 75 can make contact with each other. However, leg portion 65 is not at a position allowing contact with protrusion 78 or protrusion 79, and leg portion 75 is also not at a position allowing contact with protrusion 68 or protrusion 69.

Next, referring to FIG. 10, the contact state of upper plunger 60 and lower plunger 70 after wiring board 200 is installed and before IC package 100 is installed will be described.

When wiring board 200 is installed on base part B, lower plunger 70 is pushed up by wiring board 200, and the position of lower plunger 70 is determined (push-in position).

Even in the state shown in FIG. 10, upper plunger 60 and lower plunger 70 are in a state in which leg portion 65 and leg portion 75 face each other, and leg portion 65 and leg portion 75 can make contact with each other. However, leg portion 65 is not at a position allowing contact with protrusion 78 or protrusion 79, and leg portion 75 is also not at a position allowing contact with protrusion 68 or protrusion 69.

Next, referring to FIG. 11, the contact state of upper plunger 60 and lower plunger 70 after wiring board 200 and IC package 100 are installed will be described.

IC package 100 disposed on floating plate 50 is pushed down to the installation position, and IC package 100 is installed on base part B. When IC package 100 is installed on base part B, upper plunger 60 is pushed downward by IC package 100 (terminal 101), and the position of upper plunger 60 is determined (push-in position).

In the state illustrated in FIG. 11, upper plunger 60 and lower plunger 70 are at positions where leg portion 65 makes contact with protrusion 78, and leg portion 75 makes contact with protrusion 68. Since reduced-diameter portion 82 restricts the movement of leg portion 65 and leg portion 75 in this state as described in FIG. 5B, protrusion 68 and leg portion 75 can be brought into contact with each other reliably, and protrusion 78 and leg portion 65 can be brought into contact with each other reliably.

FIG. 12 is a view for explaining arrangement patterns of upper plunger 60 and lower plunger 70 constituting contact pin C. In the following description, in upper plunger 60 and lower plunger 70, the side where protrusion 68 and protrusion 78 are disposed is referred to as a front side, and the side where protrusion 69 and protrusion 79 are disposed is referred to as a back side.

The arrangement pattern of upper plunger 60 and lower plunger 70 shown in FIG. 11 is a front-to-front arrangement pattern shown in FIG. 12. In this case, as described above, protrusion 68 and leg portion 75 come into contact with each other, and protrusion 78 and leg portion 65 come into contact with each other.

The arrangement pattern of upper plunger 60 and lower plunger 70 is not limited to the front-to-front arrangement pattern shown in FIG. 12, and may be front-to-back arrangement pattern, a back-to-front arrangement pattern, and a back-to-back arrangement pattern.

Even in the case of the front-to-back arrangement pattern shown in FIG. 12, protrusion 69 and leg portion 75 come into contact with each other, and protrusion 78 and leg portion 65 come into contact with each other similarly to the description in FIG. 11.

Also in the case of the back-to-front arrangement pattern shown in FIG. 12, protrusion 68 and leg portion 75 come into contact with each other, and protrusion 78 and leg portion 65 come into contact with each other similarly to the description in FIG. 11.

Also in the case of the back-to-back arrangement pattern shown in FIG. 12, protrusion 69 and leg portion 75 come into contact with each other, and protrusion 79 and leg portion 65 come into contact with each other similarly to the description in FIG. 11.

As is understood, in all four possible arrangement patterns, upper plunger 60 and lower plunger 70 are in contact with each other at two points, so that an electrically reliable connection can be ensured.

Here, although the configuration in which the protrusions are provided on both surfaces of both upper plunger 60 and lower plunger 70 is shown, the same effect can be obtained even in the configuration in which the protrusions are provided on both surfaces of one of upper plunger 60 and lower plunger 70.

### Summary

As described above, in the present embodiment, contact pin C includes upper plunger 60 and lower plunger 70. In one of upper plunger 60 and lower plunger 70, trunk portion 64 or trunk portion 74 includes protrusions 68, 69 or protrusions 78, 79 on both sides of a portion that faces leg portion 75 or leg portion 65 when upper plunger 60 and lower plunger 70 are in the push-in position.

Protrusions 68, 69 or protrusions 78, 79 make contact with leg portion 75 or leg portion 65 when upper plunger 60 and lower plunger 70 are in the push-in position, making it possible to reliably connect upper plunger 60 to lower plunger 70. As a result, the signal quality of IC socket 10 can be improved, and stable electric characteristics can be obtained.

Further, in both upper plunger 60 and lower plunger 70, trunk portion 64 and trunk portion 74 may include protrusions 68 and 69 and protrusions 78 and 79. In this case, upper plunger 60 and lower plunger 70 can be electrically connected to each other securely at two points, so that the signal quality of IC socket 10 can be further improved and more stable electrical characteristics can be obtained.

In addition, one or both of upper plunger 60 and lower plunger 70 includes protrusions 68, 69 and/or protrusions 78, 79 on both surfaces. Therefore, regardless of how upper plunger 60 and lower plunger 70 are arranged at the time of assembly, upper plunger 60 and lower plunger 70 can be electrically and securely connected to each other, and the assemblability of contact pin C can be improved.

Further, since contact pin C is composed of upper plunger 60, lower plunger 70, and spring 80, the number of parts can be reduced, and the cost can be reduced.

Further, since spring 80 includes reduced-diameter portion 82 as described above, the movement of upper plunger 60 and lower plunger 70 can be restricted when upper plunger 60 and lower plunger 70 are in contact with each other, and thus the electrical connection can be ensured. As a result, the electrical characteristics can be stabilized.

Further, since upper plunger 60 and lower plunger 70 include end portions 66 and 76 in a scalene triangle shape, upper plunger 60 is not caught to be made unmovable during the replacement or maintenance of contact pin C. Therefore, assemblability at the time of replacement or maintenance of contact pin C can be improved, and replacement or maintenance of contact pin C can be easily performed.

### Variation of Plunger

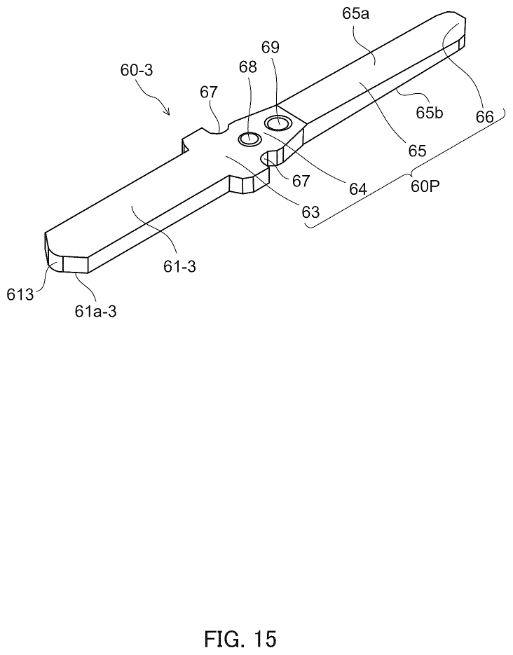

FIG. 13 is a perspective view illustrating upper plunger 60-1, which is a variation of head portion 61 and electrode part 61a of upper plunger 60. FIG. 14 is a perspective view illustrating upper plunger 60-2, which is another variation of head portion 61 and electrode part 61a of upper plunger 60. FIG. 15 is a perspective view illustrating upper plunger 60-3, which is still another variation of head portion 61 and electrode part 61a of upper plunger 60.

The configurations of head portions 61-1, 61-2, and 61-3 of Upper plunger 60-1 shown in FIG. 13, upper plunger 60-2 shown in FIG. 14, and upper plunger 60-3 shown in FIG. 15 mainly differ from head portion 61 of upper plunger 60. On the other hand, in upper plunger 60-1 shown in FIG. 13, upper plunger 60-2 shown in FIG. 14, and upper plunger 60-3 shown in FIG. 15, plate surface part 60P has the same configuration as upper plunger 60. Therefore, in upper plunger 60-1 shown in FIG. 13, upper plunger 60-2 shown in FIG. 14, and upper plunger 60-3 shown in FIG. 15, the configuration of plate surface part 60P is denoted by the same reference numerals as plate surface part 60P of upper plunger 60, and redundant explanation will be omitted.

In upper plunger 60-1 illustrated in FIG. 13, head portion 61-1 has a shape obtained by bending a plate member having a flat plate shape so as to have a U-shaped cross section (cross section of a U shape turned sideways). Electrode part 61a-1 disposed on one end side (right side in FIG. 13) of head portion 61-1 includes a plurality of (for example, four in FIG. 13) protruding electrodes 611 along a U-shape that is the shape of one end side of head portion 61-1.

In upper plunger 60-2 illustrated in FIG. 14, head portion 61-2 has a shape of a plate member having a flat plate shape. Upper plunger 60-2 includes no neck portion 62, and head portion 61-2 extends along the same plane from shoulder portion 63 of plate surface part 60P. Electrode part 61a-2 disposed on one end side (left side in FIG. 14) of head portion 61-2 includes a plurality of (for example, two in FIG. 14) protruding electrodes 612 along an I-shape that is the shape of one end side of head portion 61-2.

In upper plunger 60-3 illustrated in FIG. 15, head portion 61-3 has a shape of a plate member having a flat plate shape. Upper plunger 60-3 also includes no neck portion 62, and head portion 61-3 extends along the same plane from shoulder portion 63 of plate surface part 60P. Electrode part 61a-3 disposed on one end side (right side in FIG. 15) of head portion 61-3 has one protruding electrode 613.

In FIGS. 13 to 15, upper plungers 60-1, 60-2, and 60-3, which are variations of upper plunger 60, are illustrated, but variations of lower plunger 70 may have the same configuration as upper plungers 60-1, 60-2, and 60-3, and illustration and description thereof are omitted here.

In the present invention, upper plunger 60-1 and a lower plunger having a configuration similar to that of upper plunger 60-1 may be used instead of upper plunger 60 and lower plunger 70. Similarly, upper plunger 60-2 and a lower plunger having a configuration similar to that of upper plunger 60-2, or upper plunger 60-3 and a lower plunger having a configuration similar to that of upper plunger 60-3 may be used. Even when upper plunger 60-1 and the lower plunger having the same configuration as that of upper plunger 60-1 are used, the above-described operation and effect of the present invention can be obtained. Similarly, upper plunger 60-2 and a lower plunger having a configuration similar to that of upper plunger 60-2, or upper plunger 60-3 and a lower plunger having a configuration similar to that of upper plunger 60-3 can also be used to achieve the operation and effects of the present invention described above.

Further, one of upper plunger 60 and upper plungers 60-1 to 60-3, and one lower plunger 70 and the lower plungers having the configurations similar to those of upper plungers 60-1 to 60-3 may be combined. Even in this case, the operation and effects of the present invention described above can be obtained.

Note that, the aforementioned embodiments merely describe examples of implementations for practicing the present invention, and should not be construed as limiting the technical scope of the present invention. That is, the present invention can be implemented in various forms without departing from its spirit or key features.

### REFERENCE SIGNS LIST

10 IC socket
20 Frame part
21 Accommodating portion
22 Guide portion
30 Upper base part
31 Through-hole
32 Upper main portion
33 Upper locking portion
34 Upper reduced-diameter portion
35 Upper surface
40 Lower base part
41 Through-hole
42 Lower main portion
43 Lower locking portion
44 Lower reduced-diameter portion
45 Lower surface
50 Floating plate
51 Through-hole
60, 60-1, 60-2, 60-3 Upper plunger
60P Plate surface part
61, 61-1, 61-2, 61-3 Head portion
61a, 61a-1, 61a-2, 61a-3 Electrode part
62 Neck portion
63 Shoulder portion
64 Trunk portion
65 Leg portion
65a Front surface
65b Back surface
66 End portion
67 Recessed portion
68, 69 Protrusion
70 Lower plunger
71 Head portion
71a Electrode part
72 Neck portion
73 Shoulder portion
74 Trunk portion
75 Leg portion
75a Front surface
76 End portion
77 Recessed portion
78, 79 Protrusion
80 Spring
81 Upper enlarged-diameter portion
82 Reduced-diameter portion
83 Lower enlarged-diameter portion
100 IC package
101 Terminal
200 Wiring board
610, 611, 612, 613 Protruding electrode
B Base part
C Contact pin
S Hollow portion

1. A contact pin, comprising:
a pair of plungers capable of being pushed into a socket from respective directions in an upper-lower direction, wherein
the pair of plungers include plate surface parts, respectively, each of the plate surface parts extending in the upper-lower direction and including an electrode part at one of end sides, the pair of plungers being disposed such that one of the electrode parts faces upward, other one of the electrode parts faces downward, and the plate surface parts face each other, the pair of plungers being configured to be movable in the upper-lower direction between an initial position and a push-in position of each of the pair of plungers, and
one of the plate surface parts includes a protrusion on both surfaces of a portion of the one plate surface part which comes to face other one of the plate surface parts when both of the pair of plungers are positioned at the push-in position, the protrusion being capable of making point contact or local contact with the other plate surface part.

2. The contact pin according to claim 1, wherein
the other plate surface part includes a protrusion on both surfaces of a portion of the other plate surface part which comes to face the one plate surface part when both of the pair of plungers are positioned at the push-in position, the protrusion being capable of making point contact or local contact with the one plate surface part.

3. The contact pin according to claim 2, wherein
the protrusion is a hemispherical shape or a spherical segment shape.

4. The contact pin according to claim 2, wherein
at least one surface of both surfaces of each of the plate surface parts is configured such that the one plate surface part and the protrusion of the other plate surface part make contact with each other and the other plate surface part and the protrusion of the one plate surface part make contact with each other when both the pair of plungers are positioned in the push-in position, and such that the one plate surface part and the protrusion of the other plate surface part are separated from each other and the other plate surface part and the protrusion of the one plate surface part are separated from each other when at least one of the pair of plungers is positioned in the initial position.

5. The contact pin according to claim 4, wherein
at least one surface of the both surfaces of each of the plate surface parts is a inclined surface inclined with respect to the upper-lower direction.

6. The contact pin according to claim 1, wherein
an end portion at other one of the end sides of each of the plate surface parts has a scalene triangle shape as seen in a plate-thickness direction.

7. The contact pin according to claim 4, further comprising:
a spring into which the plate surface parts of the pair of plungers are inserted respectively from opposite ends, the spring being configured to support the pair of plungers in an expandable and contractible manner in the upper-lower direction, wherein
the spring includes a restricting portion for restricting radially outward movement of both the plate surface parts caused by a reaction force caused by a contact between the one plate surface part and the protrusion of the other plate surface part and a contact between the other plate surface part and the protrusion of the one plate surface part when both of the pair of plungers are positioned in the push-in position.

8. The contact pin according to claim 7, wherein
the restricting portion is a reduced-diameter portion disposed in a middle portion of the spring and having a diameter smaller than a diameter of an enlarged-diameter portion existing in an upper portion and a lower portion of the spring.

9. A socket, comprising:
a base part including a through-hole penetrating in an upper-lower direction; and
the contact pin according to claim 1 that is inserted into the through-hole and which the electrode parts on upper and lower sides are electrically connectable to terminals of different electrical components, respectively.

10. A plunger forming a contact pin and capable of being pushed into a socket from one direction in an upper-lower direction, wherein:
the plunger includes a plate surface part extending in the upper-lower direction and including an electrode part at one of end sides, the plunger being configured to be movable in the upper-lower direction between an initial position and a push-in position, the plunger being disposed to be oriented opposite another plunger in the upper-lower direction in a state in which the plate surface part faces a plate surface part of the another plunger, the another plunger forming a pair with the plunger, and
the plate surface part includes a protrusion on both surfaces of a portion of the plate surface part which comes to face the plate surface part of the another plunger when both of the plunger and the another plunger are positioned at the push-in position, the protrusion being capable of making point contact or local contact with the plate surface part of the another plunger.
